(19) United States
(12) Patent Application Publication
(10) Pub. No.: US 2001/0011242 A1
(43) Pub. Date: Aug. 2, 2001

(54) SYSTEM AND METHOD FOR INTERACTIVE DISPLAY OF FINANCIAL INFORMATION AND ACCOMPANYING REPORT GENERATION

(76) Inventors: KATHERINE ROY ALLEX, BELLE MEAD, NJ (US); GEOFFREY ATKIN, BAYSIDE, NY (US); MITCHELL S. FARKAS, CRANBURY, NJ (US); MICHAEL GRISHAM, NEW YORK, NY (US); MATTHEW KANE, OYSTER BAY, NY (US); ROBERT O. KRON, MONMOUTH JCT, NJ (US)

Correspondence Address: HOPGOOD CALIMAFDE KALIL & JUDLOWE, LINCOLN BUILDING, 60 EAST 42ND STREET, NEW YORK, NY, 10165

(21) Appl. No.: 08/964,048

(22) Filed: Nov. 4, 1997

(51) Int. Cl. G06F 17/60

(52) U.S. Cl. 705/36

(57) ABSTRACT

The system includes data storage for storing current financial data on a user, as well as data relating to user defined future financial goals and events. The system also includes a unified display to graphically represent the various goals and events, as well as the projected net financial position of the user based on the stored current financial information and the future goals and events. In a preferred embodiment, the net position is displayed as a bar graph, with the goals and events being represented on categorized time lines above the graph having the same x-ordinate time scale. Each event or goal may be moved along its time line, or deactivated, to effect the projected net asset position of the user. The event or goal representations also provide simple access to the stored data underlying each of the goals and events.

Another aspect of the invention is the overall combination of a printed analysis of the user's financial situation, prepared with data gathered by a financial institution, and a computer system pre-programmed with the same data. The pre-programmed personal data and static data (e.g., tax tables, etc.) may not be altered by the user. The system includes various calculation components for viewing the effects of changes to future events and goals based on the pre-programmed data.

### FIELD OF THE INVENTION

This invention relates generally to the field of financial data processing. More specifically, the invention relates to a system and method for interactively displaying financial information such that a user may immediately view the results of changes to financial data. The invention also relates to a combination of a report and interactive system for presenting financial information based on similar data and a method for generating and delivering the combination.

### BACKGROUND OF THE INVENTION

Existing accounting and financial data systems provide the capability for users to input data relating to his/her current and future financial situation. The systems then project if the user will be able to reach his or her desired goals. It is also well-known that predictive information may also be input and changed to allow the user to see the effect of change on the data.

In most of these systems, however, it is common for both the input data and the output data to be displayed in numerical form. It is also common for these systems to only focus on one particular calculation at a time. For example, a mortgage calculator will show the recalculated monthly payment when the interest rate or term is changed, but not much else. As a result, it is difficult for the user to get a complete picture of his or her overall financial situation, if so desired. As another example, one calculation may relate to the capital needed to purchase an item. By entering the amount already saved, the amounts to be periodically saved, and the assumed interest rate, the system will calculate at what point the user will have saved sufficient funds to purchase the item. This may even be presented graphically, as a bar graph showing the accumulated funds. By repeating this process for various individual calculations, the user's overall financial picture may emerge, but will require significant synthesis of data within the user's mind (or at least on paper or a spreadsheet).

It is also known that the user's total financial picture may be shown on a unified, single graph, such as with a pie chart or a bar graph. This often involves merely totaling the various calculations from other modules to arrive at a projected net worth. To show the expected growth or decline of the user's net worth, a bar graph may be utilized to show the value over time, with each bar representing a different year. To alter the underlying variables, such as goals and life events and their date of effect, however, it is necessary to open a different module to be able to select the event or goal, change the data and then carry the data back over to the net worth component. Only then will the system recompute the total picture. The user must then switch back to the summary screen to view the recalculated expectations. It is therefore difficult to immediately see the effects of changes, which may make the significance of those changes almost undetectable by the user.

Many of these systems are also intended for use solely by the end user, meaning that the user must input the data on which the calculations are made. The user then selects which calculations he/she wishes and the program performs them. Once entered, the user may alter the personal data and obviously affect the calculations output. However, often, these changes will not reflect the user's true current financial picture, and misleading responses from the programs may result. Users may also receive a printed analysis alone from their financial institution, but the analysis is of course static. To change the analysis, one must have the financial institution change the underlying data and generate another printed report.

### SUMMARY OF THE INVENTION

In view of the prior art, it is an object of the invention to provide a system that will display simultaneously multiple items of financial data.

It is another object of the invention to provide a system that allows the user to interact with a single display to alter data and immediately see the effects of such changes.

It is a further object of the invention to provide a system that allows the user to change the selected date of data points by graphic manipulation.

It is a still further object of the invention to provide a system that provides immediate access to various data groups from a single display.

It is yet another object of the invention to provide a system that provides for multiple variables to be changed and displayed simultaneously on a single display.

It is a yet further object of the invention to provide a system that provides a unified view of a user's overall financial situation, including various goals and other factors that affect that situation.

It is still another object of the invention to provide a user with a printed report of his/her financial situation, in combination with a pre-input program based on similar data.

It is a still further object of the invention to provide a system that complements the written report and allows the user to vary future events without being able to affect personal data.

In accordance with the objects of the invention, a system is provided that includes data storage for storing current financial data on a user, as well as data relating to user defined future financial goals and events. The system also includes a unified display to graphically represent the various goals and events, as well as the projected net financial position of the user based on the stored current financial information and the future goals and events. In a preferred embodiment, the net position is displayed as a bar graph, with the goals and events being represented on categorized time lines above the graph having the same x-ordinate time scale. Each event or goal may be moved along its time line, or deactivated, to effect the projected net asset position of the user. The event or goal representations also provide simple access to the stored data underlying each of the goals and events.

Another aspect of the invention is the overall combination of a printed analysis of the user's financial situation, prepared with data gathered by a financial institution, and a computer system pre-programmed with the same data. The pre-programmed personal data and static data (e.g., tax tables, etc.) may not be altered by the user. The system includes various calculation components for viewing the effects of changes to future events and goals based on the pre-programmed data.

### BRIEF DESCRIPTION OF THE DRAWINGS

The above objects and advantages will become apparent to those skilled in the art upon reading the following detailed description of the preferred embodiments in conjunction with a review of the appended drawings, in which:

FIG. 1 is an overall schematic diagram showing the generation and use of the system of the present invention;

FIG. 2 is a unified display of financial information according to the preferred embodiment of the present invention;

FIG. 3 is a unified display as in FIG. 2, with a modified event;

FIG. 4 is a unified display as in FIG. 2, with a modified event;

FIG. 5 is a detail screen for an education goal of the preferred embodiment;

FIG. 6 is a detail screen for a purchase goal of the preferred embodiment;

FIG. 7 is a detail screen for an income event of the preferred embodiment;

FIG. 8 is a detail screen for an expense event of the preferred embodiment; and

FIG. 9 is a schematic showing the relationship of data in a printed report and the pre-programmed system of the present invention.

### DETAILED DESCRIPTION OF THE PREFERRED EMBODIMENTS

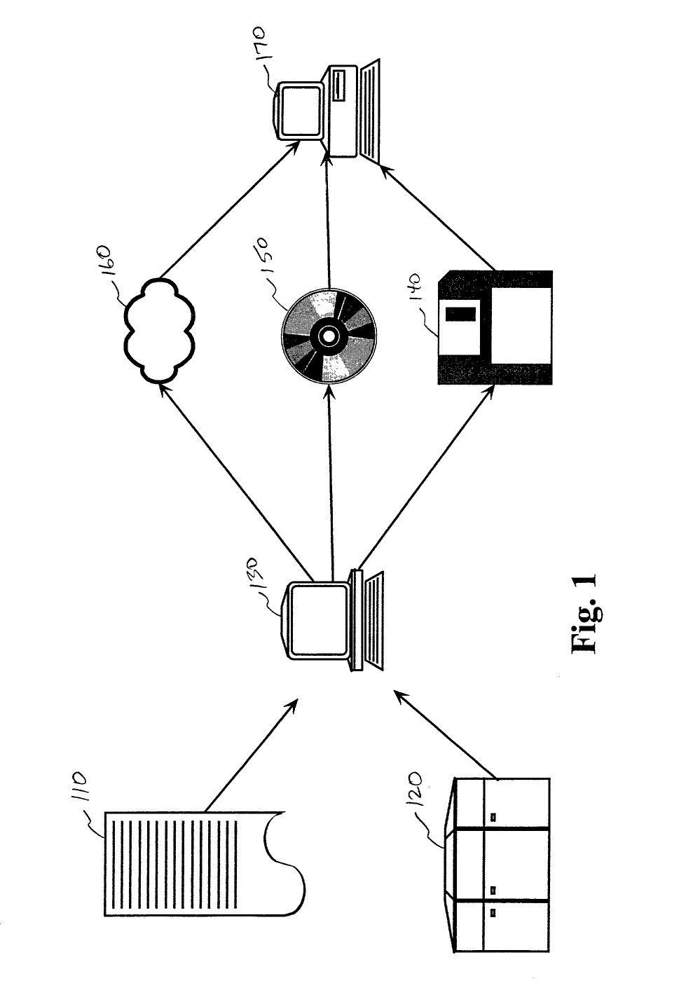

Referring now to FIG. 1, the generation and use of the present invention is shown in schematic diagram form. Initially, it is preferred that a user's current financial information is input into the system of the present invention. This may be accomplished through the filling out of a form 110, either paper or computer, from which data is then input into the system. It is also preferred that the data may be electronically transferred from another system, such as a bank or brokerage system 120, which already contains the user's current financial data. Once the user's financial data is entered, it is preferred that the system prevent changes to personal data by the user. Personal data relates to the user's current personal profile. The personal data includes, for example, such information as the number of children and the user's age. Most of this data is static—primarily only future financial data changes for the user. However, the user is allowed to change limited current data, such as current income. In that way, future financial events may be affected by the user and the projected effect displayed, so that each system is tailored and pre-programmed specifically for the user. Another user would need another pre-programmed system tailored for them. This also reduces erroneous calculation results based on inadvertently and incorrectly entered or altered current data. The system also has pre-programmed limits to help prevent the user from entering erroneous data.

The data from the user profile is preferably entered into a computer 130 and incorporated into the system for later analysis and display by the user. The system, including the user's data, is then displayed on a workstation that is accessible by the user. This may include forwarding the system code and data together to the user for use on his/her own machine on some transportable media, such as a floppy disk 140 or CD-ROM 150. Alternatively, assuming secure transfer can be achieved, the system and data may be transferred to the user over the Internet 160. Preferably, however, the user views the system on a terminal 170 at a centralized location, such as a branch of the financial institution that generated the system. Preferably, the terminal 170 has at least a 486-type microprocessor running at 33 MHZ with 16 megabytes of memory and standard 640×480 video resolution. Other terminals and methods of accessing the system will work similarly.

After the data is entered, the user may perform a myriad of calculations. These include summary calculations on the current overall net position, as well as breaking down the current financial data to facilitate understanding by the user. These specific calculations that may be made only with respect to the current data are not critical to the present invention. Some of these calculations are known in the art in various accounting and money management systems.

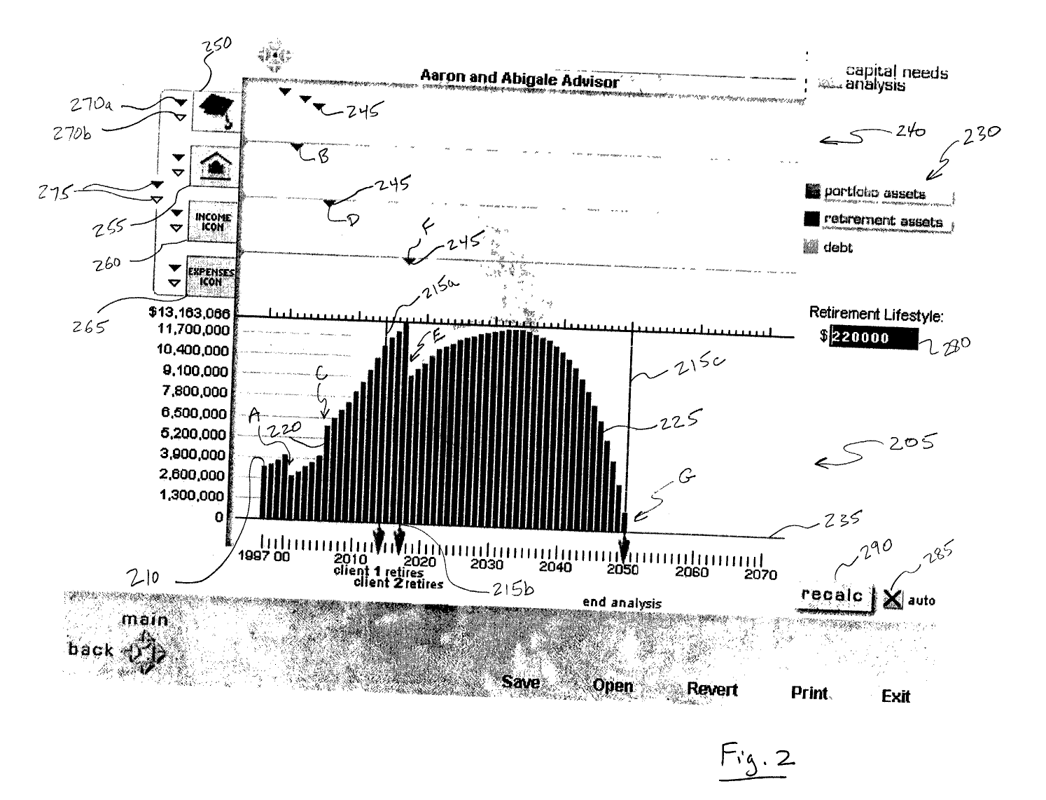

Referring now to FIG. 2, the capital needs analysis screen of the system of the present invention is seen. The screen is composed of several components, which will be discussed in detail below. As an overview, on the lower portion 205 of the screen is a graph showing the overall net assets for the user from the current data through the selected end of the analysis. The net asset data is the result of calculations made by the system based on the personal data previously entered and the various events and goals. The graph is preferably a bar graph with each bar 210 representing a separate year. On the graph, there are several vertical lines 215a, 215b, 215c indicating certain landmarks in the asset analysis. One line 215a represents the year in which the first user retires. Another line 215b represents the year in which the second user, such as a spouse, retires. Obviously, if there is no second user, there will be no other line. The asset bars continue year by year until a third vertical line 215c, which represents the end of the analysis. Initially, these vertical lines with pointers at the bottom are set to the year positions input into the user's profile survey. However, as will be seen below, these lines may be moved to affect the asset analysis shown on the graph.

Within the graph, each bar 210 for each year is color coded to designate what type of funds are shown within that year. For example, a bar for a particular graph will likely include two types of funds—investments 220 and retirement funds 225. This distinction between the sources of funds may help the user to see how his or her future cash needs will be met by investments versus retirement funds. The user can also see the effects of different asset allocations on the future cash resources. A legend 230 corresponding to the these colors is preferably located on the right hand side of the screen. If at any point, the user's overall cash flow becomes negative, a bar for that year, which will be entirely below the zero line, is colored red to indicate debt. A horizontal line 235 also preferably appears on the graph to indicate the zero asset level.

The upper portion 240 of the screen shown in FIG. 2 includes various events and goals 245 that also affect the asset analysis. Each of these events is placed in a horizontal orientation such that their position corresponds to the time line of the x axis of the assets graph shown in the lower portion of the screen. Preferably, the events are categorized into four categories: education 250, savings goals 255, inflows 260, and outflows 265, although other categories could be similarly added or substituted. Within each category, there may be any number or no events.

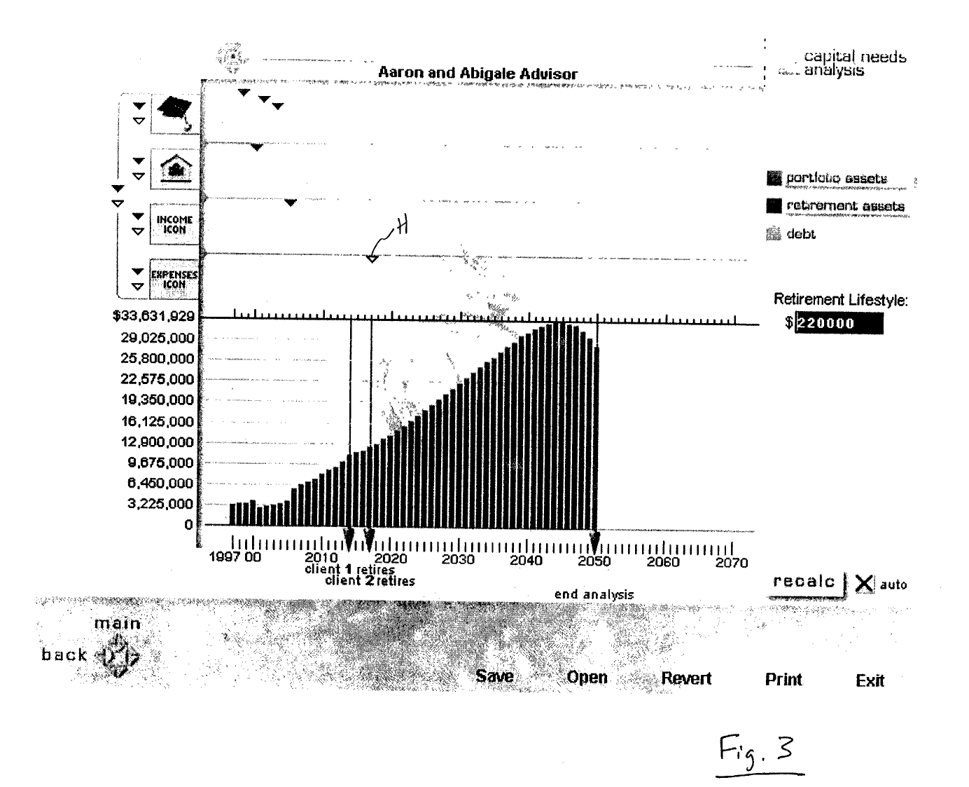

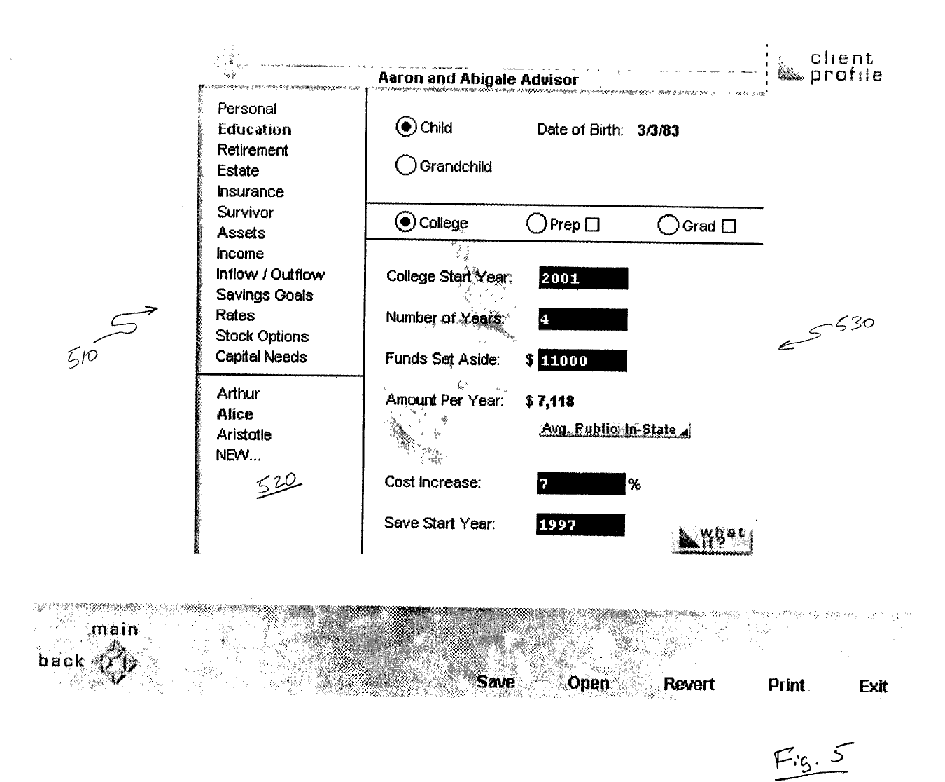

Each of the event categories and event markers 245 have multiple functions. Each of the four categories has a main icon which allows the user to access editing screens for that category and either add another event or edit an existing event from that category. When one of the four main category icons is pressed, the system initiates an input screen for that particular category. Those input screens are shown in FIGS. 5 through 8, and are discussed more fully below. Immediately adjacent each of the main icons are two marker icons 270a, 270b which allow the user to turn off and on all events in the corresponding category. Two global icons 275 allow the user to turn all of the events on and off. Individual event markers may be activated or inactivated by simply “clicking” on them. “Clicking” is preferably by a mouse button or other pointing device, although any graphical selecting device will work similarly. When the event is not selected to be included in the calculation shown on the lower graph, the event marker becomes outlined without color (see FIG. 3, at 310). When an event is either turned on or off, the system will recalculate the graph shown in the lower portion of the screen, assuming the user has selected the automatic recalculation option (at 285). If the recalculation is not automatic, the user may cause a recalculation by pressing the recalculation button 290.

Since the horizontal location of each event marker also corresponds to the year on which the event occurs, as well as corresponding to the time line of the lower graph, the user may move the markers to change the date on which the events affect the asset calculations. When any event marker that is active is moved along the horizontal direction, the system automatically recalculates the graph on the lower portion of the screen, again assuming that the user has selected the automatic recalculation option.

When the user puts the cursor over an event marker, the name and currently selected year for that event are displayed in the upper right area of the screen. To call up a form for entering or altering the data associated with that marker, the user merely double-clicks on that marker. For example, FIG. 5 shows the data screen for an education event.

The projected net asset calculations performed for the graph on the lower portion of the screen are based on the annual outlay of capital the user expects to need in a given year. For those years spent in retirement, this is entered in the field 280 on the right side of the screen of FIG. 2 under “Retirement Lifestyle.” This number may also be changed at will by the user to cause the system to recalculate the projected net assets based on the new desired annual outlay. Pre-retirement lifestyle is displayed on the Profile screen for capital needs and can be changed by manipulating values on a client profile Income screen.

Referring now to FIG. 5, it can be seen that the data screen associated with any particular event is preferably separated into two sections. The left side 510 of the data screen is a list of all event types that may be entered and ultimately effect the net asset screen. This allows the user to switch to a different event without first going back to the net asset screen. Within each event type, such as education shown in FIG. 5, titles 520 for each event of that type are shown at the bottom of the left hand side of the screen to allow the user to select a specific one.

The right side 530 of the data screen includes the various fields of data associated with that event. Many of the fields associated with the event may be pre-filled with data from the client profile previously entered. These fields and others not retrieved from the profile may be entered or altered by the user as desired, unless the data field relates to static personal data.

The remaining event type screens are shown in FIGS. 5 through 8. The specific data that is entered and the specific event calculations that are performed are not critical to the present invention, so long as the event calculations will produce sufficient data to be incorporated by the system into the net asset analysis on an annualized basis. It is contemplated that other event categories and sub-categories may be chosen and implemented without departing from the spirit and function of the invention.

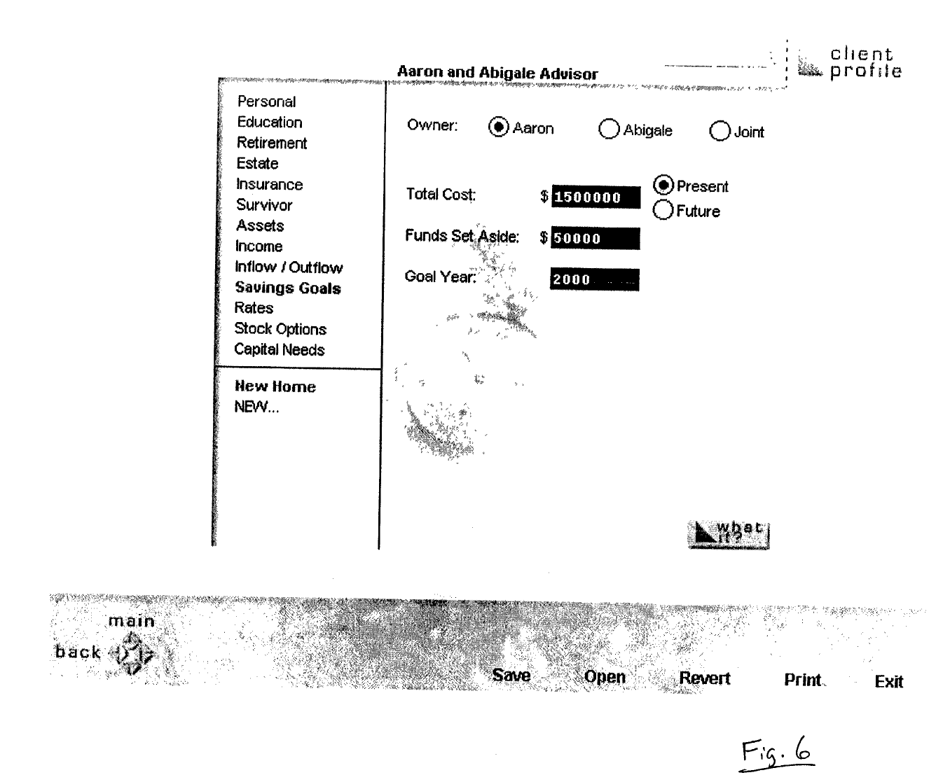

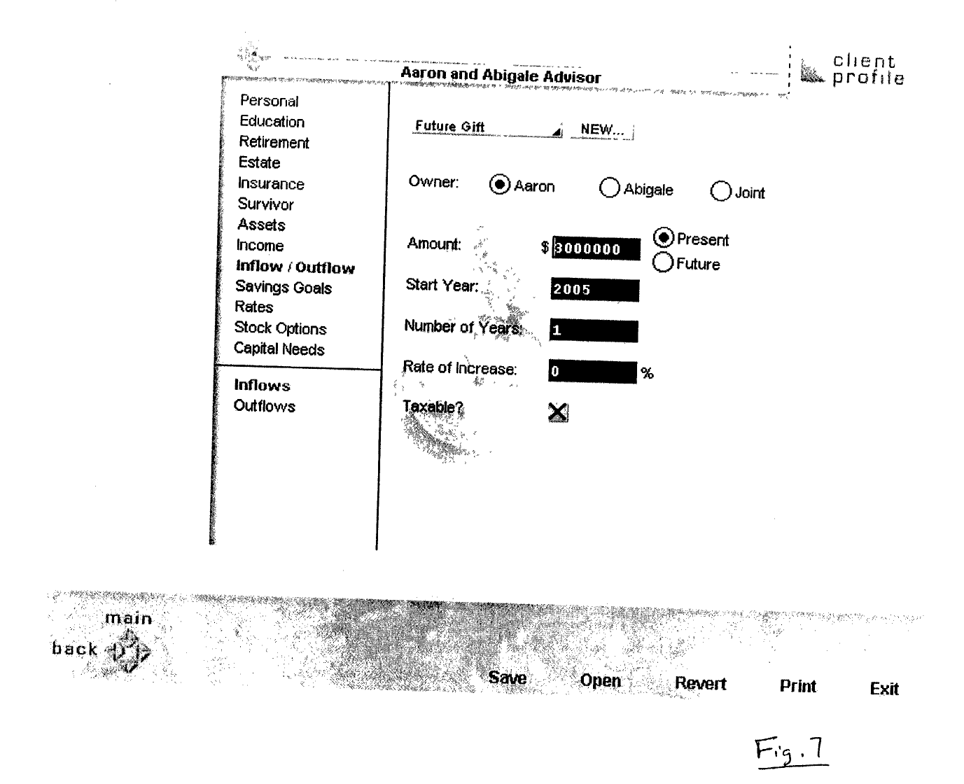

As an example of the operation of the present system, FIGS. 2 through 4 will be discussed. On FIG. 2, the effect of the various events can be seen on the user's net worth on the graph in the lower portion. At A, the decrease in projected net assets is due to the outlay of 1.5 million dollars for the “New Home” that is indicated by marker B, with the underlying data shown in FIG. 6. At C, the net asset increases by a future gift the user expects to receive of 3 million in 2005, indicated by marker D, with the underlying data shown in FIG. 7. The net asset falls again by 4 million in 2017 at E, upon buying a home for the grandparents “GP home,” indicated by marker F.

The overall net asset picture is also projected not to be particularly healthy, as the portfolio assets will be gone by 2022 and the user will be nearly out of assets should he or she live to 2050 (at G). To determine how to avoid that situation, the user can adjust the events and immediately watch the resulting effect on the projected net assets. For example, in FIG. 3, the user has inactivated the marker at H. In other words, the user has decided not to purchase the home for the grandparents. Without that 4 million drain in 2017, the user could end up with nearly 29 million if he/she lives to 2050.

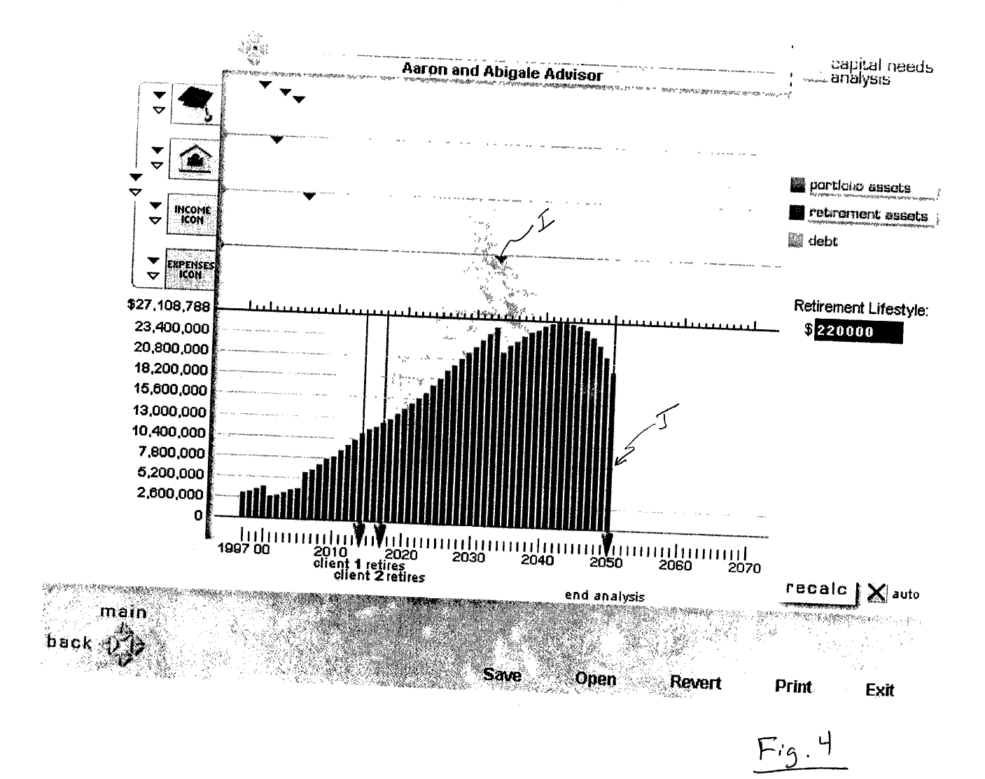

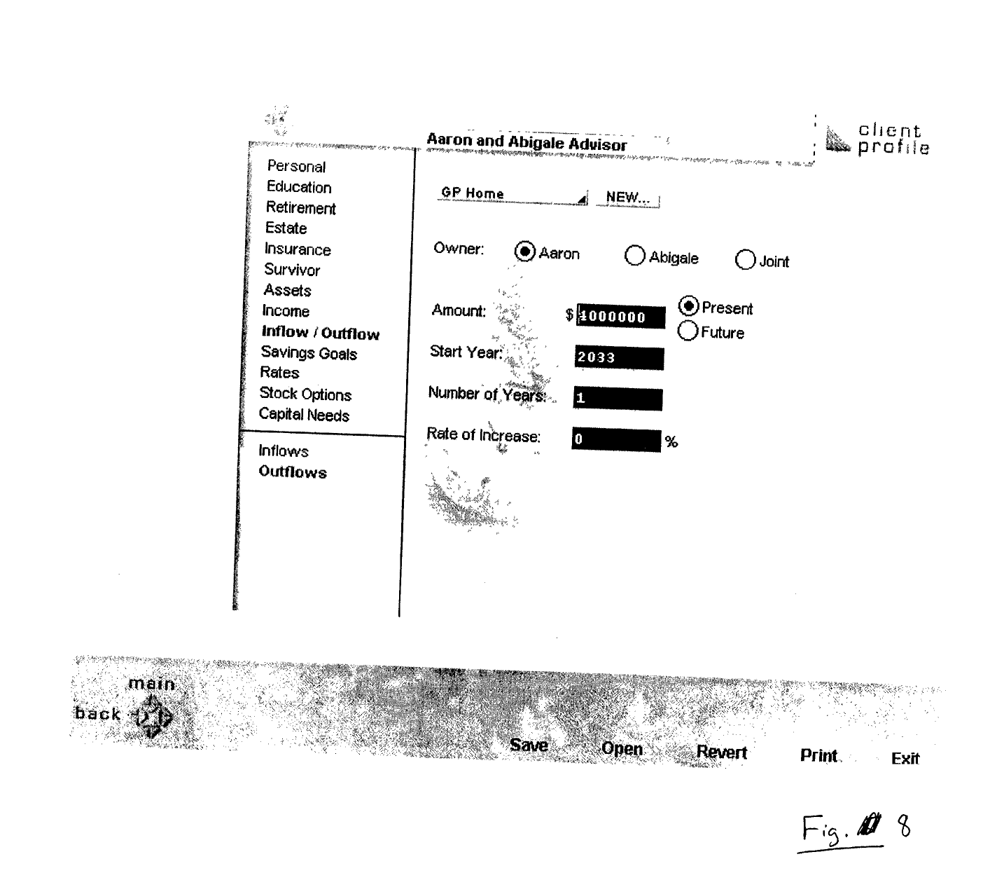

Similarly, in FIG. 4, the user has chosen to put the purchase of the grandparents home off until 2033. By simply clicking and dragging the marker at I to its new location corresponding to 2033 on the time line of the asset graph, the system will recalculate the overall projected net assets. The automatically changed underlying data, brought up by double-clicking the marker I is shown in FIG. 8. By moving the purchase, the user has also managed to avoid potential bankruptcy and is projected to end up with approximately 19 million in 2050 (at J).

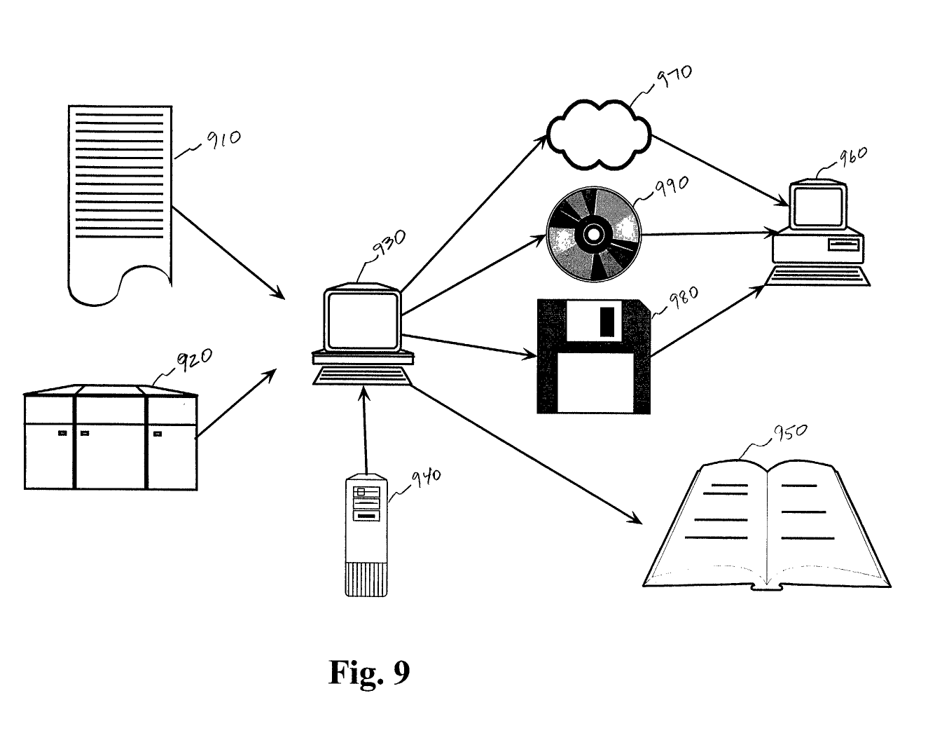

Another aspect of the invention relates to the generation of a printed report in combination with access to the system of the present invention. The generation of this combination is shown schematically in FIG. 9. Data relating to the user's current financial situation is again provided to the financial institution as described above (forms 910, electronic transfer 920, etc.). The information is entered into a computer 930, which merges the data with the system code 940 of the present invention. The financial institution then performs its own analysis and selected group of calculations to generate a printed report 950 reflecting the user's financial situation and projected future. In addition to the user's personal data, the financial institution also preferably adds proprietary information relating to recommendations for the user to take and how to accomplish his/her goals.

Along with the printed report 950, the financial institution also uses the same input personal data and pre-programs it into a copy of the system code of the present invention. That copy of the system code is now customized for the one user and will be inapplicable to another user. The system, as partially described above, gives the user the opportunity to alter future goals and events, as well as any calculations that include entries other than personal data. The user is preferably prevented from altering the personal data by using a data file that must be maintained in a set size and data format. Since the data file is preferably undelimited, it is difficult to know which text to alter and then to alter it without rendering the system inoperative.

The customized system is then made available to a terminal 960 for the user to observe and use. This can be accomplished as described above, by internet 970, floppy disk 980, or CD-ROM 990. When the customized system is generated, the data file for the intended user and the reference data (such as current tax tables) are written to the media (or transmitted by network) when requested. This ensures that the reference data is current as of the data it is incorporated into the system. Preferably, the customized system is written to floppy disks 980 with two disks being mass produced with the static system application elements and a third disk being custom produced with the user data and the reference data.

Thus, it can be seen that the system of the present invention provides a comprehensive interactive environment for easily visualizing a user's projected future capital needs and assets. The system also provides maximum flexibility to alter data easily to immediately view the effect such alterations will have on the user's projected overall financial picture. The invention also provides a combination of a hard copy printed report and the system, both customized and based on the same personal user data for maximum impact to the user.

While the above embodiments of the present invention are fully capable of achieving the objects and advantages of the present invention, it is to be understood that these embodiments are shown and described solely for the purposes of illustration and not for the purpose of limitation, the invention being only limited by the claims.

What is claimed is:

1. A system for calculating and displaying financial information, comprising:
a display;
a means for calculating resulting data from personal data;
a graphical representation of the resulting data displayed on said display, said representation having a time dimension;
a graphical representation of an event displayed on said display, said event representing a portion of said personal data, said graphical representation being movable on said display in a direction corresponding to said time dimension;
such that when said graphical representation of said event is moved in said direction, said means for calculating recalculates said resulting data, said first graphical representation then reflecting the recalculated resulting data.

2. A system as in claim 1, wherein said personal data is comprised of personal data and event data, said personal data being unalterable by a user of said system, said event data being associated with said second graphical representation.

3. A system as in claim 1, further comprising multiple second graphical representations of events, each event being independently movable.

4. A system as in claim 3, wherein each of said events may be independently inactivated, said means for calculating recalculating said resulting without the portion of said personal data associated with any inactivated event.

5. A system as in claim 4, wherein each of said second graphical representations of events may be independently selected to cause a display of the portion of personal data associated with the selected event.

6. A system for generating and relaying financial data to a user, comprising:
personal financial data relating to said user;
means for calculating resulting data from said personal financial data;
a report generator for producing a hard copy report of said resulting data;
a display;
a first graphical representation of said resulting data on said display;
a second graphical representation of a portion of said personal financial data on said display;
means for manipulating said graphical representation on said display such that said portion of said personal data may be altered; and
means for recalculating said resulting data based on said altered personal data.

7. A system for providing a user with a report and interactive display of resulting financial data based on personal financial data for said user, comprising:
a data processor;
means for inputting said personal financial data into said data processor, said data processor generating said resulting financial data from said personal financial data;
means for outputting a hard copy report of said resulting financial data for said user;
means for generating a computer program incorporating said resulting financial data for said user, said computer program being capable of displaying said resulting financial data on a computer display;
said computer program comprising means for manipulating a portion of said personal financial data on said computer display and means for recalculating said resulting data based on the manipulated personal data.
